(19) United States
(12) Patent Application Publication
(10) Pub. No.: US 2011/0216748 A1
(43) Pub. Date: Sep. 8, 2011

(54) WIRELESS COMMUNICATION APPARATUS AND WIRELESS COMMUNICATION METHOD

(75) Inventor: Eiji KAWASE, Kokubunji-shi (JP)

(73) Assignee: SEIKO EPSON CORPORATION, Tokyo (JP)

(21) Appl. No.: 13/039,781

(22) Filed: Mar. 3, 2011

(30) Foreign Application Priority Data
Mar. 8, 2010 (JP) 2010-050876

(51) Int. Cl. H04W 4/00

(52) U.S. Cl. 370/338

(57) ABSTRACT

A wireless apparatus includes: a module executing communication with a target wireless apparatus in conformity with a first communication standard and a second communication standard having the higher maximum communication rate; a connection unit establishing connection with the target wireless apparatus by transmitting and receiving a frame to and from the target wireless apparatus; a data communication unit executing data communication with the target wireless apparatus; and a communication rate control unit controlling the module, when the connection unit establishes the connection, so that the module executes the communication in conformity with the first communication standard when there is the first wireless apparatus, whereas the module executes the communication in conformity with the second communication standard when there is no first wireless apparatus and controlling the module to execute the communication in conformity with the second communication standard, when the data communication unit executes the data communication.

The entire disclosure of Japanese Patent Application No. 2010-050876, filed Mar. 8, 2010 is expressly incorporated by reference herein.

### BACKGROUND

1. Technical Field

The present invention relates to a wireless communication apparatus and a wireless communication method, and more particularly, to a printer connectable to a network.

2. Related Art

A wireless LAN (Local Area Network) apparatus such as a printer connectable to a wireless LAN tries to communicate with a target wireless apparatus which transmits data such as print data to perform printing at a higher rate, at the maximum communication rate at which the corresponding wireless LAN apparatus can perform communication. Among the wireless LAN communication standards such as IEEE 802.11b, IEEE 802.11a, IEEE 802.11g, and IEEE 802.11n, IEEE 802.11n particularly has the maximum communication rate of 600 Mbps and realizes high-rate communication.

According to IEEE 802.11n, high-rate communication can be realized. However, transmission and reception frequently fail at the maximum communication rate due to the influence of the distance between apparatuses, a blocking object, or a radio wave environment. When transmission and reception fail, the present communication rate is lowered and retransmission is tried to realize normal transmission and reception communication.

JP-A-2009-218629 is an example of the related art.

When a wireless LAN apparatus executes data communication with a target wireless apparatus, it is necessary for the wireless LAN apparatus to establish wireless connection (wireless link) in advance together with the target wireless apparatus. The wireless connection is established by a wireless connection sequence executed between the wireless LAN terminal and the target wireless apparatus. In the wireless connection sequence, there is no communication guarantee of a network upper protocol. When transmission and reception fail in the wireless connection sequence, a problem with the so-called “not connected” phenomenon may arise. For example, due to the failure to execute the transmission and reception, a time-out occurs while the communication rate is lowered and retransmission is repeated, and therefore, before the establishment of the wireless connection, the wireless connection sequence may come to an end mid-way.

This problem frequently occurs with the coexistence of terminals executing communication according to a plurality of wireless LAN standards. For example, with the coexistence of both a terminal executing communication in conformity with IEEE 802.11n and a terminal executing communication in conformity with IEEE 802.11b, the terminal using IEEE 802.11b does not understand the details (the communication details executed by the terminal using IEEE 802.11n) of the frames transmitted and received by the terminal using IEEE 802.11n, and thus there is a possibility that the communication of the terminal using IEEE 802.11n may be disturbed due to the radio wave interference of the terminal using IEEE 802.11b.

### SUMMARY

An advantage of some aspects of the invention is that it provides a wireless communication apparatus and a wireless communication method capable of establishing reliable wireless connection with a target wireless apparatus in spite of the coexistence of wireless apparatuses using communication standards with different communication rates.

According to an aspect of the invention, there is provided a wireless communication apparatus including: a wireless module executing wireless communication with a target wireless apparatus in conformity with a first wireless communication standard and a second wireless communication standard having the maximum communication rate higher than that of the first wireless communication standard; a network environment acquisition unit acquiring, from the target wireless apparatus, network environment information used to specify whether there is a first wireless apparatus executing communication in conformity with the first wireless communication standard within a communication area of the target wireless apparatus; a wireless connection unit establishing wireless connection with the target wireless apparatus by transmitting and receiving a frame to and from the target wireless apparatus via the wireless module; a data communication unit executing data communication with the target wireless apparatus, with which the wireless connection unit has established the wireless connection, via the wireless module; and a communication rate control unit (A) controlling the wireless module, when the wireless connection unit establishes the wireless connection, so that the wireless module executes the communication in conformity with the first wireless communication standard when there is the first wireless apparatus within the communication area, whereas the wireless module executes the communication in conformity with the second wireless communication standard when there is no first wireless apparatus within the communication area and (B) controlling the wireless module to execute the communication in conformity with the second wireless communication standard, when the data communication unit executes the data communication.

The communication rate control unit may control the wireless module to execute the communication at the minimum communication rate of the first or second wireless communication standard, when the wireless connection unit establishes the wireless connection.

The communication rate control unit may control the wireless module to execute at the maximum communication rate of the second wireless communication standard, when the data communication unit executes the data communication.

The first wireless communication standard may include at least one of IEEE 802.11b, IEEE 802.11a, and IEEE 802.11g. The second wireless communication standard may include IEEE 802.11n.

According to another aspect of the invention, there is provided a wireless communication method of executing wireless communication with a target wireless apparatus, including: acquiring, from the target wireless apparatus, network environment information used to specify whether there is a first wireless apparatus executing communication in conformity with a first wireless communication standard within a communication area of the target wireless apparatus; selecting the first wireless communication standard when there is the first wireless apparatus within the communication area, whereas selecting a second wireless communication standard having the maximum communication rate higher than that of the first wireless communication standard when there is no first wireless apparatus within the communication area, based on the network environment information; establishing wireless connection with the target wireless apparatus by transmitting and receiving a frame to and from the target wireless apparatus in conformity with the selected wireless communication standard; and executing data communication with the target wireless apparatus, with which the wireless connection unit has established the wireless connection, in conformity with the second wireless communication standard.

According to the aspects of the invention, the reliable wireless connection can be established with the target wireless apparatus in spite of the coexistence of wireless apparatuses executing communication in conformity with communication standards with different communication rates.

### BRIEF DESCRIPTION OF THE DRAWINGS

The invention will be described with reference to the accompanying drawings, wherein like numbers reference like elements.

FIG. 1 is a block diagram schematically illustrating the configuration of a wireless LAN network including a printer in FIG. 2.

FIG. 2 is a block diagram schematically illustrating the inner configuration of a printer according to an embodiment of the invention.

FIG. 3 is a flowchart illustrating a connection establishment phase.

FIG. 4 is a flowchart illustrating a data communication phase.

FIGS. 5A and 5B are diagrams illustrating the formats of an ERP information element and an HT operation element, respectively.

FIG. 6 is a flowchart illustrating determination of a communication rate in conformity with a used communication standard.

FIG. 7 is a diagram illustrating a correspondence table between a network environment and a communication rate.

FIGS. 8A and 8C are diagrams illustrating the formats of an HT capabilities element, an extended supported rates element, and a supported rate element, respectively.

### DESCRIPTION OF EXEMPLARY EMBODIMENTS

Hereinafter, an embodiment of the invention will be described with reference to the drawings.

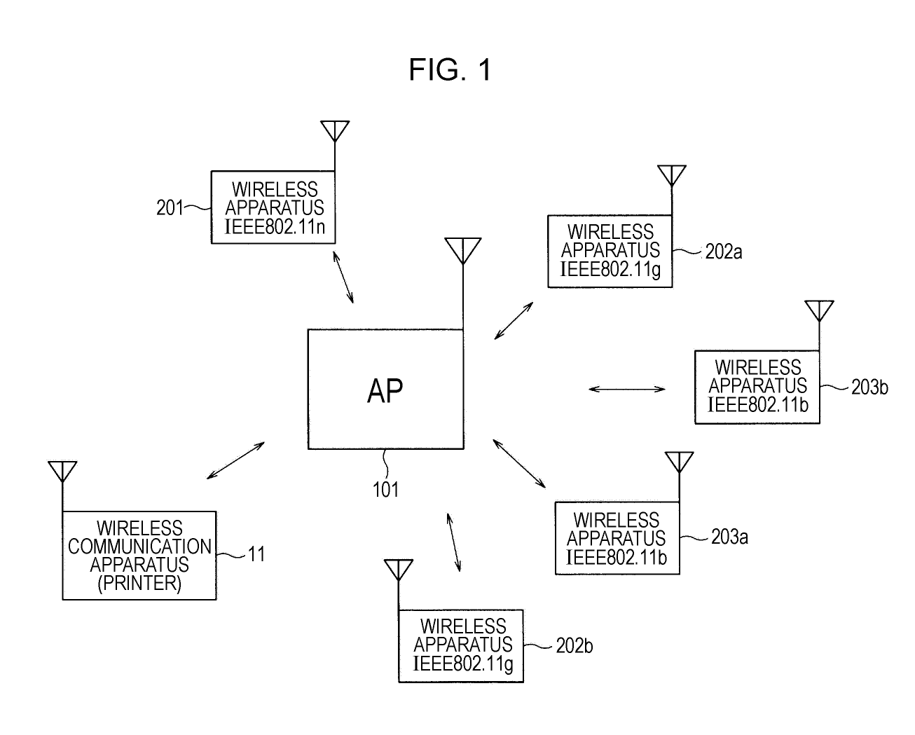

FIG. 1 is a diagram schematically illustrating the configuration of a wireless LAN (Local Area Network) system that includes a printer (wireless communication apparatus) 11 according to an embodiment of the invention, wireless apparatuses 201, 202a, 202b, 203a, and 203b, and an access point (AP) 101 relaying communication among the printer 11 and these wireless apparatuses.

The printer 11 and the access point 101 execute communication in conformity with IEEE 802.11n as a communication standard and execute communication also in conformity with IEEE 802,11b, IEEE 802.11g, and IEEE 802.11a. The frequency bands of the IEEE 802,11b and IEEE 802.11g are, for example, the 2.4 GHz band and the frequency band of the IEEE 802.11a is, for example, the 5 GHz band. The frequency band of IEEE 802.11n is different depending on the modes and is a broadband including the 2.4 GHz band, the 5 GHz band, or both thereof. The maximum communication rate of IEEE 802.11n is higher than that of IEEE 802,11b, IEEE 802.11g, and IEEE 802.11a. For example, the maximum communication rate of IEEE 802.11n is 600 Mbps.

IEEE 802.11b, IEEE 802.11g, and IEEE 802.11a correspond to a first wireless communication standard according to the invention and IEEE 802.11n corresponds to a second wireless communication standard according to the invention which has the maximum communication rate higher than that of the first wireless communication standard. A wireless apparatus executing communication in conformity with one of IEEE 802.11b, IEEE 802.11g, and IEEE 802.11a corresponds to a first wireless apparatus according to the invention.

There are a plurality of wireless apparatuses within the communication area of the access point 101. In the example of FIG. 1, there are the wireless apparatus 201 executing communication in conformity with IEEE 802.11n, the wireless apparatuses 202a and 202b executing communication in conformity with IEEE 802.11g, and the wireless apparatuses 203a and 203b executing communication in conformity with IEEE 802.11b.

The wireless apparatuses 202a and 202b using IEEE 802.11g also execute communication in conformity with IEEE 802.11b due to mutual compatibility of IEEE 802.11g. The wireless apparatus 201 using IEEE 802.11n also executes communication in conformity with IEEE 802.11b and IEEE 802.11g due to mutual compatibility with IEEE 802.11n. A wireless apparatus executing communication in conformity with IEEE 802.11a may also be present within the communication area of the access point 101. In this case, the wireless apparatus 201 using IEEE 802.11n also executes communication in conformity with IEEE 802.11a due to mutual compatibility with IEEE 802.11n.

The printer 11, which is a printer connectable to a network, executes data communication with the wireless apparatus 201 using IEEE 802.11n. For example, when the printer 11 receives an instruction to print data from the wireless apparatus 201, the printer 11 prints and outputs the instructed data on a sheet. The access point 101 relays the data communication between the printer 11 and the wireless apparatus 201. The printer 11 and the access point 101 execute the data communication in conformity with IEEE 802.11n.

In the example of FIG. 1, the printer has been used as one wireless communication apparatus according to the invention, but the invention is not limited to the printer as the wireless communication apparatus according to the invention. Examples of the wireless communication apparatus according to the invention include a personal computer, a scanner apparatus, a copy machine, a mobile communication apparatus such as a PDA or a cellular phone, a game console apparatus, and a home electrical appliance. The respective wireless apparatuses shown in FIG. 1 may be arbitrary apparatuses such as a personal computer, a scanner apparatus, a copy machine, a printer, a mobile communication apparatus, a game console apparatus, and a home electrical appliance.

In FIG. 1, an infrastructure mode is shown in which the printer 11 communicates with the wireless apparatus 201 using IEEE 802.11n via the access point 101. However, an ad-hoc mode may be used in which the printer 11 directly communicates with the wireless apparatus 201 without involving the access point 101.

Thus, a target wireless apparatus with which the printer 11 directly communicates may be the access point 101 or another wireless apparatus different from the access point 101.

The data communication between the printer 11 and the wireless apparatus 201 using IEEE 802.11n is executed according to a print protocol operating on a network protocol. At this time, before the data communication is executed, it is necessary for the printer 11 to establish wireless connection (establish a wireless link) in advance with the access point 101 in the lower MAC layer (Layer 2) of the network protocol. According to this embodiment, the so-called “not connected” phenomenon is prevented from occurring and a reliable wireless connection is established, even when there are wireless apparatuses using communication standards (IEEE 802.11b, IEEE 802.11g, IEEE 802.11a, and the like) different from IEEE 802.11n within the communication area of the access point 101.

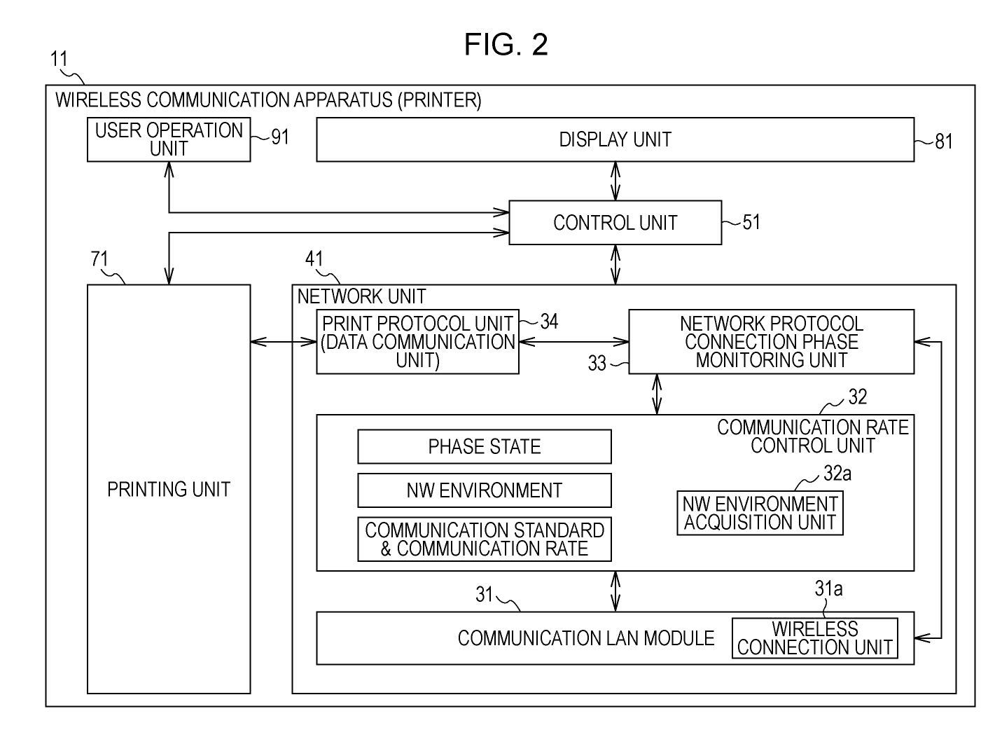

FIG. 2 is a block diagram schematically illustrating the inner configuration of the printer 11 according to an embodiment of the invention.

The printer 11 includes a user operation unit 91, a display unit 81, a control unit 51, a printing unit 71, and a network unit 41.

The user operation unit 91 include keys and buttons through which a user inputs various instructions for the printer 11 and receives the instructions from the user through the keys and the buttons. For example, the user inputs various instructions such as a power on/off instruction, a print detail setting instruction, and a display setting instruction using the keys or the buttons. The user operation unit 91 may receive an input through a remote controller.

The display unit 81 is an output interface that displays image data for the user. For example, the display unit 81 is a liquid crystal display (LCD) apparatus. The liquid crystal display apparatus may be a transmissive liquid crystal display apparatus that displays images using light emitted from a backlight unit or a reflective liquid crystal display apparatus that displays images using outside light such as illumination light or solar light. The display unit 81 is not limited to the liquid crystal display apparatus, but may be an organic EL display apparatus, a plasma display apparatus, or an LED display apparatus. When the display unit 81 includes a function of inputting instructions through a touch panel, the user operation unit 91 may be omitted. Moreover, the same or different input function as that of the user operation unit 91 may be equipped in the display unit 81 while the user operation unit 91 is provided.

The printing unit 71 has a function of printing image data on a sheet such as a print sheet. The printing unit 71 includes a reception unit that receives sheets. The printing unit 71 receives a printing instruction from a print protocol unit 34 of the network unit 41, prints the image data designated by the print protocol unit 34 on the sheet, and outputs the printed sheet to a discharging tray. A printing method may be any one of an ink jet method, a laser beam method, a thermal transfer method, and the like. The printer 11 may be a multi-function apparatus that has additional functions such as a copy function, a fax function, and a telephone function in addition to a print function.

The network unit 41 is a communication interface with a wireless LAN. The network unit 41 includes a wireless LAN module (wireless module) 31, a communication rate control unit 32, a network protocol connection phase monitoring unit 33, and a print protocol unit (data communication unit) 34.

The wireless LAN module 31 having, for example, a plurality of communication antennas executes communication in conformity with IEEE 802.11n and also executes communication in conformity with IEEE 802.11b, IEEE 802.11g, and IEEE 802.11a. The execution of the communication in conformity with IEEE 802.11b, IEEE 802.11g, and IEEE 802.11a may be realized by the upper compatibility of IEEE 802.11n or may be realized by a chip conforming to each communication standard. The wireless LAN module 31 executes communication according to a communication standard and a communication rate (a modulation method and an encoding ratio) designated by the communication rate control unit 32.

The wireless LAN module 31 includes a wireless connection unit 31a that establishes wireless connection (wireless link) with a target wireless apparatus (in this embodiment, the access point 101). The wireless connection unit 31a transmits and receives frames to and from the target wireless apparatus to establish the wireless connection. The print protocol unit 34 described below executes data communication under the wireless connection established in this way. The printer 11 has a connection establishment phase including a wireless connection sequence in which the wireless connection is established and a data communication phase executing data communication under the established wireless connection.

In the data communication after the wireless connection establishment, the wireless LAN module 31 generates a MAC layer frame by receiving a transmission packet from the network protocol connection phase monitoring unit 33 and adding a header, an FCS, and the like into the transmission packet, when transmitting data. The wireless LAN module 31 generates a modulation signal by encoding and modulating the frame and transmits the modulation signal from the communication antenna.

The wireless LAN module 31 receives the signal via the communication antenna and restores the frame by demodulating and decoding the received signal, when receiving data. The header of the restored frame is removed and an error detection processing is performed based on the FCS. In the data communication after the wireless connection establishment, a packet of the IP layer which is payload data is extracted from the frame and the extracted packet is transmitted to the network protocol connection phase monitoring unit 33. When an error is detected through the error detection process, the corresponding frame is abolished and a retransmission request frame requesting retransmission of the frame may be transmitted. This process particularly corresponds to a Block Ack Method. The wireless LAN module 31 may perform adaptive modulation to control a communication rate according to an error rate of the frame.

The communication rate control unit 32 controls the operation of the wireless LAN module 31. In particular, in this embodiment, the communication rate control unit 32 includes a network environment acquisition unit (NW environment acquisition unit) 32a that acquires and manages a network environment (NW environment) of a wireless LAN. The NW environment acquisition unit 32a stores information regarding the acquired network environment in an internal storage unit or an external storage unit. The network environment indicates whether there are wireless apparatuses using given communication standards within the communication area of the access point 101. For example, when there are only the wireless apparatuses using IEEE 802.11n and IEEE 802.11g within the communication area of the access point 101, the information regarding the network environment is “11n & 11g”. When there are the wireless apparatuses using IEEE 802.11n, IEEE 802.11b, and IEEE 802.11g within the communication area of the access point 101, the information regarding the network environment is “11n & 11b & 11g”. The network environment is acquired by transmitting and receiving a Probe Request frame and a Probe Response frame to and from the access point 101 or by receiving a Beacon frame from the access point 101. Alternatively, a dedicated frame used to notify a wireless apparatus of a network environment is defined and the access point 101 notifies the wireless apparatus of the network environment using the dedicated frame.

The communication rate control unit 32 receives a phase (a connection establishment phase or a data communication phase) for designation from the network protocol connection phase monitoring unit 43 and stores identification information regarding the designated phase in an internal storage unit (register) or an accessible external storage unit. The communication rate control unit 32 determines a communication standard and a communication rate to be used in the designated phase.

Specifically, when the connection establishment phase is designated, the communication rate control unit 32 determines the communication standard to be used in the connection establishment phase based on the network environment and designates the determined communication standard in the wireless LAN module 31. Moreover, the communication rate control unit 32 determines the communication rate to be used in the determined communication standard and designates the determined communication rate in the wireless LAN module 31. For example, the minimum communication rate of the determined communication standard is designated as the communication rate. A reliable wireless connection is established by executing the connection establishment phase according to the communication standard and the communication rate determined in this way. A flow of the determination of the communication standard will be described.

The communication rate control unit 32 designates IEEE 802.11n as the communication standard in the wireless LAN module 31, when receiving the designation of the data communication phase from the network protocol connection phase monitoring unit 33. The communication rate control unit 32 designates the maximum rate of IEEE 802.11n as the communication rate. Thus, in the data communication phase, data communication can be executed at a high rate. When the communication standard designated in the connection establishment phase is IEEE 802.11n, only the communication rate may be designated.

The communication rate control unit 32 stores and maintains information regarding the latest communication standard and the latest communication rate designated in the wireless LAN module 31 in an internal or external storage unit.

The network protocol connection phase monitoring unit 33 processes a network protocol (for example, TCP/IP or UDP/IP) and monitors the phase of the printer 11.

The network protocol connection phase monitoring unit 33 generates a packet by adding a header and a footer of the network protocol into data to be transmitted at data transmission time when transmitting the packet, as general processing of the network protocol when receiving the packet, and then transmits the generated packet to the wireless LAN module 31. The network protocol connection phase monitoring unit 33 performs sequence control, error control, and the like based on the header and the footer of the packet received from the wireless LAN module 31, rearranges the data include in the packet in a correct sequence, and transmits the data to an application of a destination, as necessary (for example, the print protocol unit 34). When omission or damage of the packet is detected, retransmission is requested to the transmission source of the packet.

The network protocol connection phase monitoring unit 33 instructs the communication rate control unit 32 to perform initialization so as to connect the printer 11 to the wireless LAN, when receiving a start instruction of a printing service from the print protocol unit 34. The communication rate control unit 32 receiving the initialization instruction acquires the network environment, as described above. After acquiring the network environment, the communication rate control unit 32 reports initialization completion to the network protocol connection phase monitoring unit 33.

The network protocol connection phase monitoring unit 33 requests the communication rate control unit 32 to perform wireless connection and designates a connection establishment phase. The communication rate control unit 32 stores the connection establishment phase as phase information in an internal or external storage unit and determines the communication standard and the communication rate to be used in the corresponding phase. The communication rate control unit 32 instructs the wireless LAN module 31 to establish the wireless connection in addition to the determined communication standard and the determined communication rate. The wireless LAN module 31 establishes the wireless connection by executing the wireless connection sequence together with the access point 101.

When the network protocol connection phase monitoring unit 33 confirms the establishment of the wireless connection through the communication rate control unit 32, the network protocol connection phase monitoring unit 33 allocates an IP address, as necessary. That is, when the IP address is not registered in advance, the network protocol connection phase monitoring unit 33 generates a packet for requesting allocation of IP address and transmits the packet to a server (for example, the access point 101) managing the allocation of IP addresses to receive the allocated IP address from the server.

The network protocol connection phase monitoring unit 33 notifies a wireless apparatus within the wireless LAN of the details of the print service provided by the printer 11 in response to the instruction from the print protocol unit 34. In response to the request from the access point 101 or the wireless apparatus, the notification may be transmitted through unicast or may be transmitted through autonomic broadcast.

The network protocol connection phase monitoring unit 33 notifies the communication rate control unit 32 of the fact (service connection establishment notification) that the print service can be used and gives instruction of the data communication phase to the communication rate control unit 32, when the establishment of the wireless connection, the acquisition of the IP address, and the service notification described above are completed. The instruction of the data communication phase may be implied when the communication rate control unit 32 is notified of the establishment of the service connection. The communication rate control unit 32 notified of the establishment of the service connection updates the phase information stored in the internal or external storage unit to the data communication phase, determines the communication standard and the communication rate for the data communication phase, and designates the communication standard and the communication rate in the wireless LAN module 31.

The print protocol unit 34 performs print protocol processing so as to allow an external wireless apparatus to control the printer 11 via the wireless LAN.

The print protocol unit 34 determines the start of the print service executed via the wireless LAN, for example, at activation time or in response to an input instruction of the user operation unit 91 and instructs the network protocol connection phase monitoring unit 33 to start the above-described print service so that the printer 11 is connected to the wireless LAN.

When the wireless connection is established between the wireless LAN module 31 and the access point 101, the print protocol unit 34 instructs the network protocol connection phase monitoring unit 33 to give notification of the details of the print service provided by the printer 11 autonomically or in response to the request from the access point 101 or the wireless apparatus.

In the data communication phase, the print protocol unit 34 acquires data (command data and image data) transmitted from the wireless apparatus, via the network protocol connection phase monitoring unit 33. The print protocol unit 34 controls the printing unit 71 so as to print the image data transmitted from the wireless apparatus on the sheet according to the details of the command data.

The control unit 51 controls the operation of each unit of the printer 11. For example, the control unit 51 instructs the network unit 41 to start the above-described print service in response to an input instruction from the user operation unit 91. Moreover, the control unit 51 changes display setting of the display unit 81 or changes print setting of the printing unit 71.

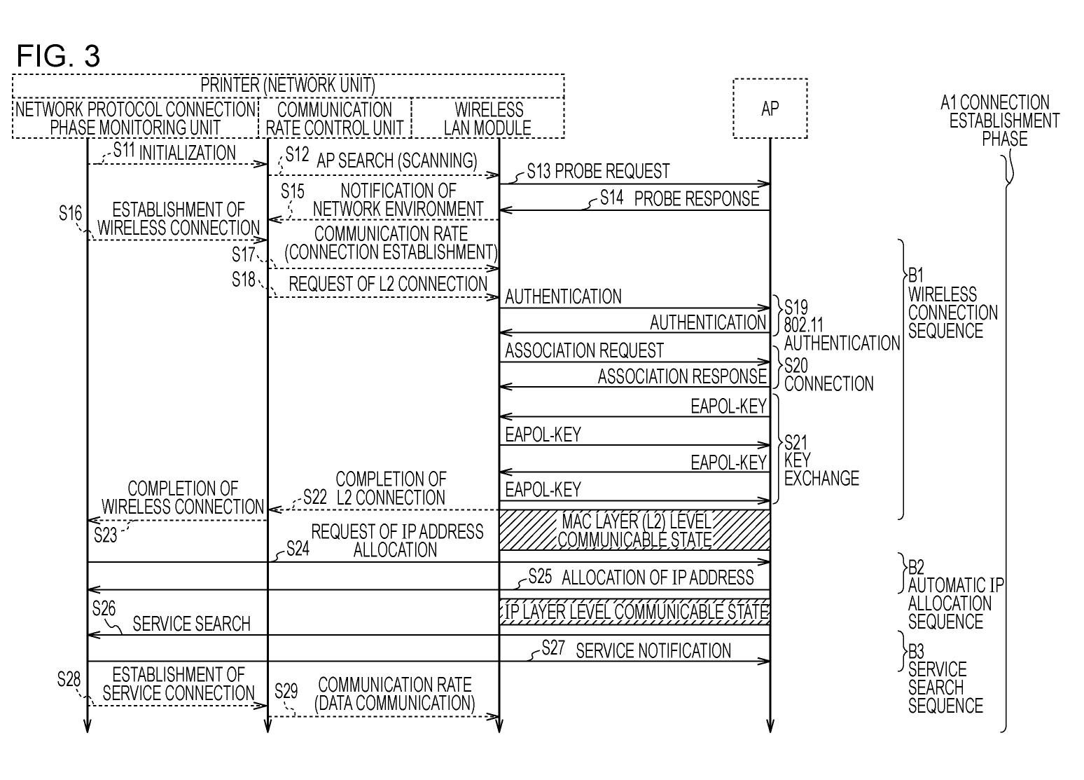

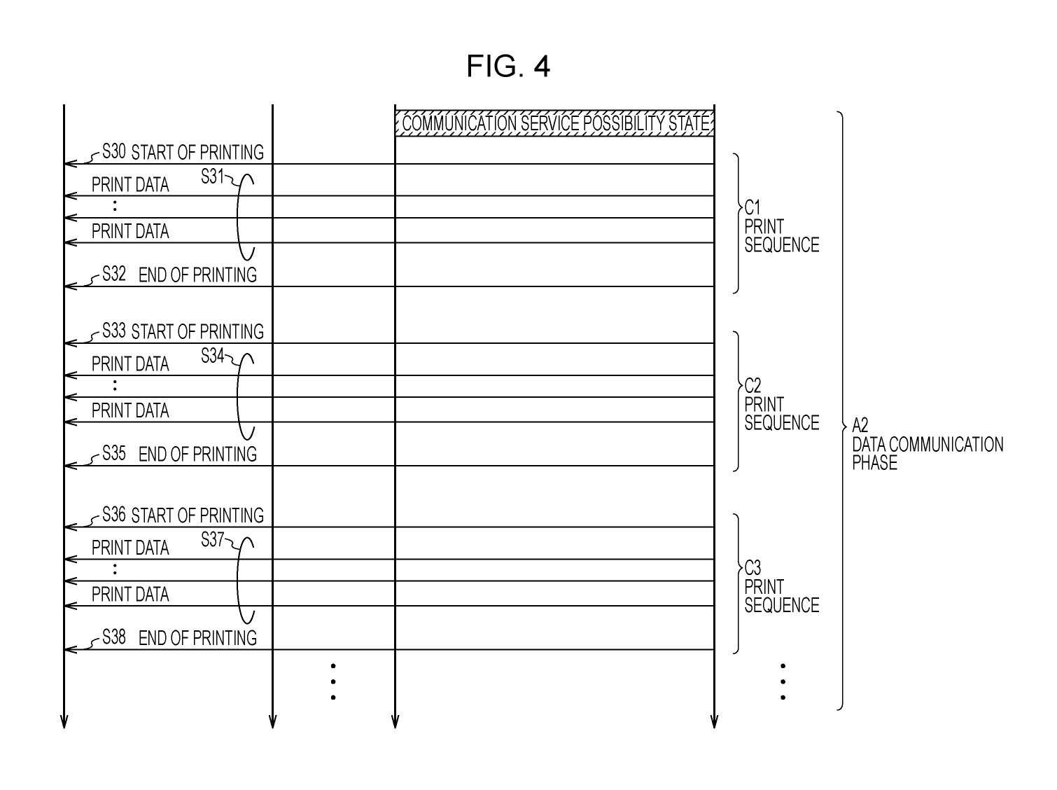

FIGS. 3 and 4 are diagrams illustrating an operation sequence executed between the printer 11 and the access point 101.

The operation between the printer 11 and the access point 101 includes a connection establishment phase A1 and a data communication phase A2 subsequent to the connection establishment phase A1. An initial procedure is executed before the connection establishment phase A1. In FIG. 3, the sequence of the connection establishment phase A1 is shown. In FIG. 4, the sequence of the data communication phase A2 is shown. The connection establishment phase A1 includes a wireless connection sequence B1, an automatic IP address allocation sequence B2, and a service search sequence B3.

In FIGS. 3 and 4, a horizontal arrow indicated by a dashed line indicates a control command transmitted and received in the printer 11. A horizontal arrow indicated by a solid line indicates a communication packet frame transmitted and received between the printer 11 and the access point 101.

### Initial Procedure

As shown in FIG. 3, the network protocol connection phase monitoring unit 33 receives an instruction to start the print service from the print protocol unit 34 and instructs the communication rate control unit 32 to perform initialization (S11). The communication rate control unit 32 receiving the initialization instruction instructs the wireless LAN module 31 to search (scan) the access point 101 (S12). At this time, the communication rate control unit 32 designates the initial communication standard and the initial communication rate determined in advance for the wireless LAN module 31. For example, the communication rate control unit 32 designates IEEE 802.11n as the communication standard and the minimum rate of this communication standard. When the initial communication standard and the initial communication rate are set in advance for the wireless LAN module 31, the above designation is not necessary.

The wireless LAN module 31 receiving the scanning instruction transmits the Probe Request frame (S13). Then, when the wireless LAN module 31 receives the Probe Response frame from the access point 101 (S14), the wireless LAN module 31 finds the access point 101.

The wireless LAN module 31 extracts information regarding the network environment of the access point 101 from the received Probe Response frame and notifies the communication rate control unit 32 of this information (S15). The information regarding the network environment is information used to specify that there is a wireless apparatus using a given communication standard within the communication area of the access point 101, as described above.

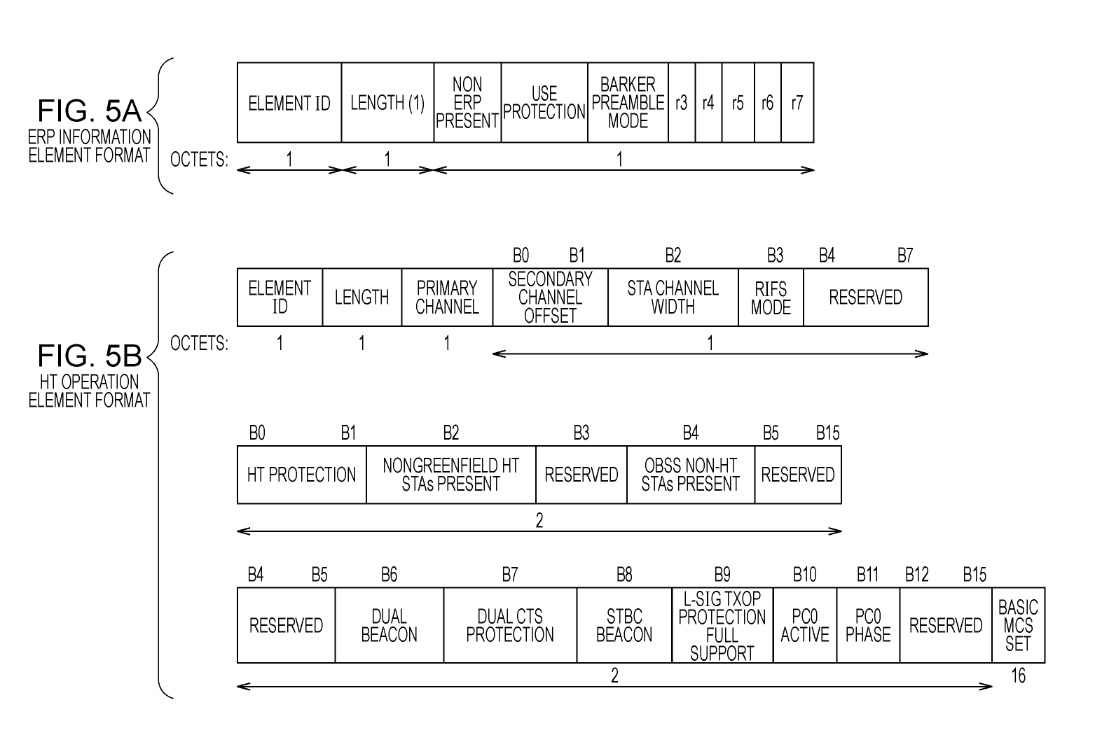

More specifically, the Probe Response frame includes an ERP information element. A Non ERP Present field of the ERP information element stores a value indicating whether there is a wireless apparatus using IEEE 802.11b within the communication area of the access point 101. When the value of the Non ERP Present field is 0, it means that there is no wireless apparatus using IEEE 802.11b. When the value of the Non ERP Present field is 1, it means that there is a wireless apparatus using IEEE 802.11b. The format of the ERP information element is shown in FIG. 5A.

The Probe Response frame includes an HT Operation element. The Nongreenfield HT STAs Present field of the HT Operation element stores a value indicating whether there are wireless apparatuses using IEEE 802.11a, IEEE 802.11b, and IEEE 802.11g within the communication area of the access point 101. When the value of the Nongreenfield HT STAs Present field is 0, it means that there are none of the wireless apparatuses using IEEE 802.11a, IEEE 802.11b, and IEEE 802.11g. When the value of the Nongreenfield HT STAs Present field is 1, it means that there is one of the wireless apparatuses using IEEE 802.11a, IEEE 802.11b, and IEEE 802.11g. The format of the HT Operation element is shown in FIG. 5B.

The wireless LAN module 31 extracts the value of the Non ERP Present field of the ERP information element and the value of the Non ERP Present field of the HT Operation element from the Probe Response frame and notifies the communication rate control unit 32 of the information regarding the network environment (S15).

In step S12 to step S15 described above, the network environment is acquired by transmitting and receiving the Probe Request frame and the Probe Response frame and finding the access point 101. However, the access point 101 may be found and the network environment may be acquired by receiving a Beacon frame periodically transmitted from the access point 101. In this case, since the Beacon frame also includes the ERP Information element and the HT Operation element described above, the value of the Non ERP Present field of the ERP information element and the value of the Nongreenfield HT SATs Present field of the HT Operation element are transmitted as the information regarding the network environment to the communication rate control unit 32 in the same way as the above-described way.

The communication rate control unit 32 notified of the network environment reports the initialization completion to the network protocol connection phase monitoring unit 33.

### Connection Establishment Phase A1

### Wireless Connection Sequence B1

The network protocol connection phase monitoring unit 33 receiving the report on the initialization requests the communication rate control unit 32 to establish the wireless connection (S16). At this time, the connection establishment phase is designated in the communication rate control unit 32. The designation of connection establishment phase may be implied in the request to establish the wireless connection.

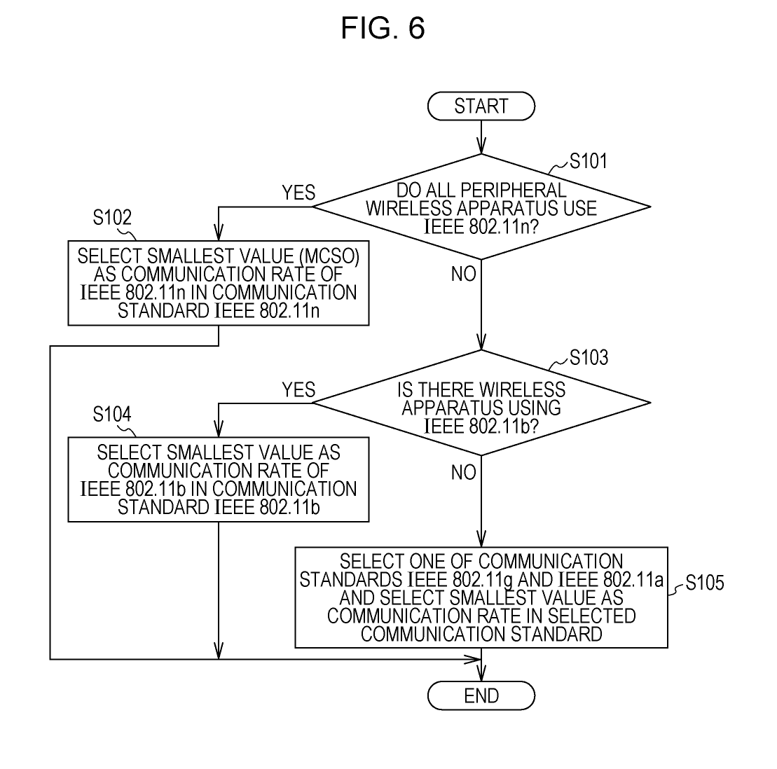

The communication rate control unit 32 requested to establish the wireless connection determines the communication standard and the communication rate commonly used in the wireless connection sequence, the automatic IP allocation sequence, and the service search sequence with reference to the flowchart of FIG. 6.

FIG. 6 is a flowchart illustrating the flow of a process of determining the communication standard and the communication rate used in these sequences.

First, the communication rate control unit 32 checks whether there are wireless apparatuses using IEEE 802.11a, IEEE 802.11b, and IEEE 802.11g within the communication area of the access point 101, that is, whether all of the peripheral wireless apparatuses using IEEE 802.11n, by confirming the value of the Nongreenfield HT STAs Present field of the HT Operation element (S101). When this value is 0, all of the peripheral wireless apparatuses are wireless apparatuses using IEEE 802.11n (Yes in S101). Therefore, in this case, the IEEE 802.11n is selected as the communication standard (S102). In order to realize a reliable communication rate, the lowest value in IEEE 802.11n, for example, MCSO (6.5 Mbps), is selected (S102). As is well-known, the modulation and coding scheme is abbreviated to MCS.

On the other hand, when the value of the Nongreenfield HT STAs Present field of the HT Operation element is 1, it is determined that there is at least one of the wireless apparatuses using IEEE 802.11a, IEEE 802.11b, and IEEE 802.11g within the communication area of the access point 101 (No S101). Next, by confirming the value of the Non ERP Present field of the ERP information element, it is checked whether there is a wireless apparatus using IEEE 802.11b (S103). When the value of the Non ERP Present field of the ERP information element is 1, it means that there is a wireless apparatus using IEEE 802.11b (Yes in S103). Therefore, IEEE 802.11b is selected as the communication standard (S104). Moreover, the smallest value in IEEE 802.11b, for example, 1 Mbps, is selected as the communication rate (S104).

On the other hand, when the value of the Non ERP Present field of the ERP information element is 0, it means that there is no wireless apparatus using IEEE 802.11b (No in S103). However, there is at least one of the wireless apparatuses using IEEE 802.11g and IEEE 802.11a. In this case, either of IEEE 802.11g and IEEE 802.11a is selected as the communication standard (S105). Moreover, the smallest value in the selected communication standard, for example, 6 Mbps (in both cases of IEEE 802.11g and IEEE 802.11a), is selected (S105).

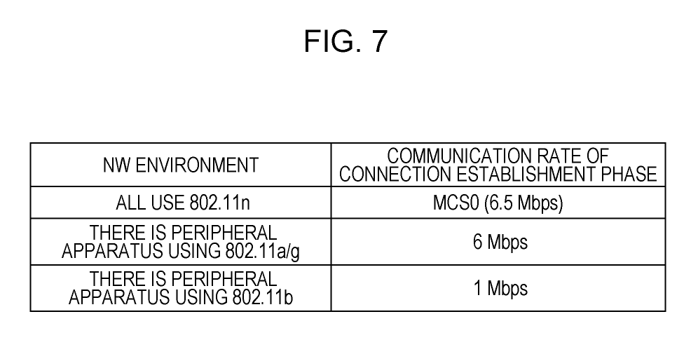

A correspondence example between the network environment and the minimum communication rate is shown in the table shown in FIG. 7.

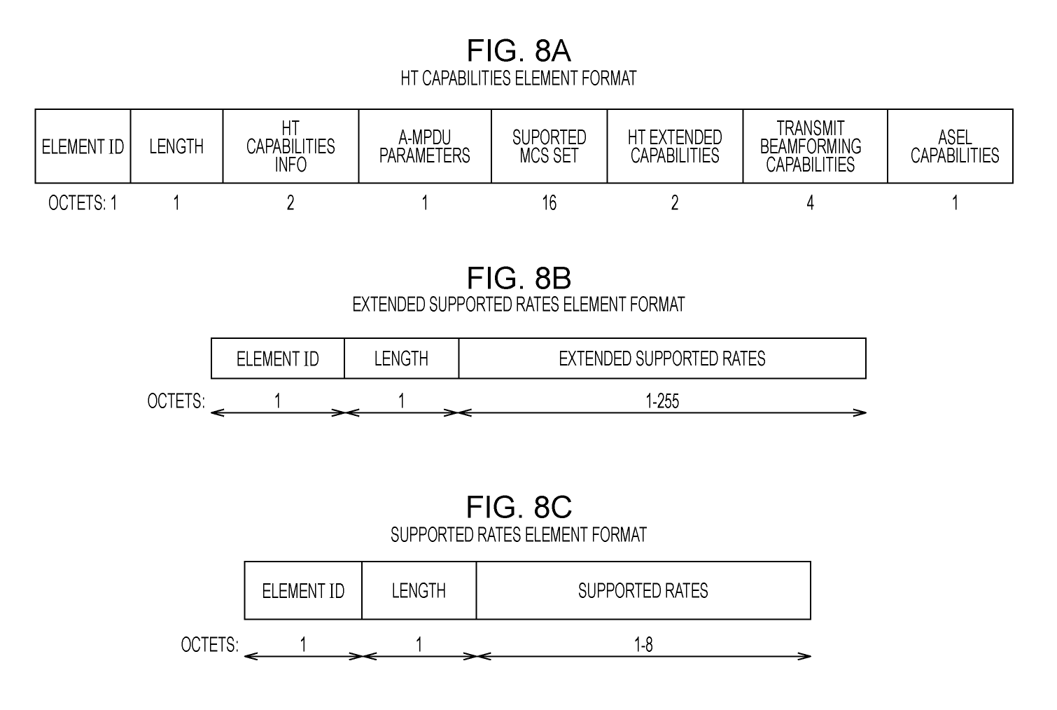

The communication rate supported in each communication standard may be set in advance in the wireless LAN module 31 or may be acquired from the Probe Response frame or the Beacon frame transmitted from the access point 101. For example, in the case of IEEE 802.11n, the supported communication rate can be acquired from the HT Capabilities element shown in FIG. 8A. In the case of IEEE 802.11g, the supported communication rate can be acquired from the Extended Supported Rates element shown in FIG. 8B. In the case of IEEE 802.11a or IEEE 802.11b, the supported communication rate can be acquired from the Supported rates element shown in FIG. 8C.

Instead of executing the flowchart of FIG. 6, a table may be generated in which the value of the Nongreenfield HT STAs Present field of the HT Operation element, the value of the Non ERP Present field of the ERP Information element, the communication standard, and the communication rate match each other. In addition, based on this table, the communication standard and the communication rate matching each other may be selected.

When the communication standard and the communication rate to be used are determined, as shown in FIG. 3, the communication rate control unit 32 designates the determined communication standard and the determined communication rate in the wireless LAN module 31 (S17). Then, the communication rate control unit 32 instructs the wireless LAN module 31 to establish the wireless connection of the MAC layer (Layer 2) (S18).

The wireless LAN module 31 receiving the instruction of the wireless connection executes the procedures of authentication, association, and key exchange together with the access point 101 according to the designated communication standard and the designated communication rate.

That is, the wireless LAN module 31 first executes the 802.11 authentication procedure by transmitting and receiving an Authentication frame together with the access point 101 (S19).

Next, the wireless LAN module 31 establishes the wireless connection with the access point 101 by transmitting and receiving an Association Request frame and an Association Response frame to and from the access point 101 (S20).

The wireless LAN module 31 establishing the wireless connection exchanges an encryption key by transmitting and receiving (4-way handshake) an EAPOL (Extensible Authentication Protocol over LAN)-key frame to and from the access point 101 (S21). When a high-level authentication (802.1x authentication) is executed, the EAP frame is transmitted and received before transmitting the EAPOL-key frame. However, it is not necessary to execute this step when the communication is executed without encryption in the MAC layer. Moreover, it is not necessary to execute this step either when using WEP or the like in which an encryption key is registered in advance as an encryption method.

When the wireless LAN module 31 executes the authentication (S19), the association (S20), and the key exchange (S21), the wireless LAN module 31 notifies the communication rate control unit 32 that the wireless connection of the MAC layer is completed (S22).

The communication rate control unit 32 receiving the above notification notifies the network protocol connection phase monitoring unit 33 that the establishment of the wireless connection is completed as a response to the request of the wireless connection received in step S16 (S23).

Thus, the wireless connection of the MAC layer (L 2) between the wireless LAN module 31 and the access point 101 is established, and thus the data communication can be realized using this wireless connection. The communication of the MAC layer is executed through encryption of the key exchanged in step S21. This encryption is executed in the wireless LAN module 31.

### Automatic IP Address Allocation Sequence B2

The network protocol connection phase monitoring unit 33 generates a frame to request allocation of an IP address and transmits the generated frame to the access point 101 via the wireless LAN module 31 (S24). The access point 101 has, for example, the function of a DHCP (Dynamic Host Configuration Protocol) server. The network protocol connection phase monitoring unit 33 receives a response frame including an allocable IP address from the access point 101 via the wireless LAN module 31 (S25). Thus, the network protocol connection phase monitoring unit 33 acquires an IP address to be used in the communication of the network layer (IP layer) to enable the communication at the level of the IP layer. In the automatic IP address allocation sequence B2, the wireless LAN module 31 executes the communication according to the communication rate and the communication standard designated in step S17 of the wireless connection sequence. When the IP address is registered in advance, it is not necessary to execute the automatic IP address allocation sequence B2.

### Service Search Sequence B3

When the print protocol unit 34 receives the service search request from the access point 101 or the wireless apparatus via the wireless LAN module 31 (S26), the print protocol unit 34 makes a response to the service notification describing the service details (for example, a print function) supplied by the printer 11 to the transmission source of the service search request via the wireless LAN module 31 (S27). In the service search sequence B3, the wireless LAN module 31 executes the communication according to the communication rate and the communication standard designated in step S17 of the wireless connection sequence.

When the transmission source of the service research request is the access point 101, the access point 101 may broadcast information regarding the received service notification to the wireless apparatuses within the communication area of the access point 101.

When the service search request is not received within a given time after the completion of the automatic IP address allocation sequence B2, this service search sequence B3 may be omitted.

In the above example, the service notification is transmitted as the response to the service search request. However, the service search request may be transmitted autonomically by broadcast after the completion of the automatic IP address allocation sequence B2.

When a given time passes after the completion of the automatic IP address allocation sequence B2 or the service notification is transmitted, the network protocol connection phase monitoring unit 33 transmits a service connection establishment notification to the communication rate control unit 32 (S28). The service connection establishment notification indicates a state (communication service possible state) in which the printer 11 can provide a service via the network.

The communication rate control unit 32 receiving the service connection establishment notification changes the setting of the phase state from the connection establishment phase to the data communication phase. Moreover, the communication rate control unit 32 determines to change the communication standard to IEEE 802.11n and to change the communication rate to the maximum communication rate of IEEE 802.11n. The communication rate control unit 32 designates the changed communication standard and the changed communication rate in the wireless LAN module 31 (S29).

### Data Communication Phase A2

As shown in FIG. 4, the print protocol unit 34 receives a print request from the wireless apparatus 201 belonging to the access point 101 and allows the printing unit 71 to print the image data designated from the wireless apparatus on a sheet (print sequence). That is, in the print sequence, the print protocol unit 34 executes the data communication with the wireless apparatus 201 according to the print protocol to print the image data on the sheet.

Specifically, in a print sequence C1, a frame including a print start instruction command is received from the wireless apparatus 201 (S30). The print start instruction command included in the frame is taken out through the wireless LAN module 31 and the network protocol connection phase monitoring unit 33 and is sent to the print protocol unit 34. Thus, the print protocol unit 34 recognizes the printing instruction and awaits the reception of the data to be printed.

The wireless LAN module 31 receives the frame included in the data to be printed from the wireless apparatus 201 (S31) and sends the data included in the frame to the print protocol via the network protocol connection phase monitoring unit 33. The print protocol unit 34 controls the printing unit 71 to print an image on a sheet based on the data.

When the wireless LAN module 31 receives the frame including a print end instruction command from the wireless apparatus 201 (S32), the wireless LAN module 31 sends the print end instruction command to the print protocol unit 34 via the network protocol connection phase monitoring unit 33. The print protocol unit 34 ends the printing according to the command and outputs the sheet.

Print sequences C2 (S33 to S35) and C3 (S36 to Se) subsequent to the print sequence C1 are also executed in the same way.

According to this embodiment of the invention, a frame is transmitted and received (S19, S20, and the like in FIG. 3) to realize the wireless connection in conformity with IEEE 802.11b, when there is a wireless apparatus using IEEE 802.11b within the communication area of the access point 101. That is, the communication is executed in the framework of IEEE 802.11b. Thus, since the details of the transmitted and received frame are understood in the wireless apparatus using IEEE 802.11b, radio wave interference caused by the wireless apparatus using IEEE 802.11b is reliably reduced and thus the reliable wireless connection is realized. At this time, by using the minimum rate of IEEE 802.11b as the communication rate, a more reliable wireless connection can be realized. In a wireless connection, traffic is small in transmission and reception and reliable communication is preferred to a high communication rate. Therefore, when there is no wireless apparatus using IEEE 802.11b within the communication area and there is a wireless apparatus using IEEE 802.11g or IEEE 802.11a, a reliable wireless connection can be realized by executing the wireless connection in conformity with IEEE 802.11g or IEEE 802.11a. At this time, a reliable wireless connection can be realized by using the minimum communication rate of IEEE 802.11g or IEEE 802.11a as the communication rate. Moreover, in this case, although the wireless connection can be realized in conformity with IEEE 802.11b, the wireless connection can be realized faster by using IEEE 802.11g or IEEE 802.11a.

In the data communication, a large amount of image data can be communicated at a high rate (for a short time) by executing the data communication at the maximum rate of IEEE 802.11n after the establishment of the wireless connection. Even when the transmission and reception fail, the data communication can reliably be completed by retransmission control of an upper protocol.

In this embodiment, the communication is executed at the minimum communication rate of the used communication standard when the wireless connection is established. However, even when the minimum communication rate is not used, a communication rate higher than the minimum communication rate may be used in a case where the communication success is anticipated. In this embodiment, the maximum communication rate of IEEE 802.11n has been used as the data communication rate. However, when the desired communication is possible, a communication rate lower than the maximum communication rate may be used.

In this embodiment, IEEE 802.11n, IEEE 802.11b, IEEE 802.11a, and IEEE 802.11b have been used as the examples of the wireless communication standards. However, the wireless communication standards applicable to the invention are not limited thereto.

Of course, the invention is not limited to the above-described embodiment, but may be modified, changed, and added in various forms according to the purpose without departing from the gist of the invention. For example, any of the units in the above-described embodiment may be omitted or new units may be added.

What is claimed is:

1. A wireless communication apparatus comprising:
a wireless module executing wireless communication with a target wireless apparatus in conformity with a first wireless communication standard and a second wireless communication standard having the maximum communication rate higher than that of the first wireless communication standard;
a network environment acquisition unit acquiring, from the target wireless apparatus, network environment information used to specify whether there is a first wireless apparatus executing communication in conformity with the first wireless communication standard within a communication area of the target wireless apparatus;
a wireless connection unit establishing wireless connection with the target wireless apparatus by transmitting and receiving a frame to and from the target wireless apparatus via the wireless module;
a data communication unit executing data communication with the target wireless apparatus, with which the wireless connection unit has established the wireless connection, via the wireless module; and
a communication rate control unit (A) controlling the wireless module, when the wireless connection unit establishes the wireless connection, so that the wireless module executes the communication in conformity with the first wireless communication standard when there is the first wireless apparatus within the communication area, whereas the wireless module executes the communication in conformity with the second wireless communication standard when there is no first wireless apparatus within the communication area and (B) controlling the wireless module to execute the communication in conformity with the second wireless communication standard, when the data communication unit executes the data communication.

2. The wireless communication apparatus according to claim 1, wherein the communication rate control unit controls the wireless module to execute the communication at the minimum communication rate of the first or second wireless communication standard, when the wireless connection unit establishes the wireless connection.

3. The wireless communication apparatus according to claim 1, wherein the communication rate control unit controls the wireless module to execute at the maximum communication rate of the second wireless communication standard, when the data communication unit executes the data communication.

4. The wireless communication apparatus according to claim 1,
wherein the first wireless communication standard includes at least one of IEEE 802.11b, IEEE 802.11a, and IEEE 802.11g, and
wherein the second wireless communication standard includes IEEE 802.11n.

5. A wireless communication method of executing wireless communication with a target wireless apparatus, comprising:
acquiring, from the target wireless apparatus, network environment information used to specify whether there is a first wireless apparatus executing communication in conformity with a first wireless communication standard within a communication area of the target wireless apparatus;
selecting the first wireless communication standard when there is the first wireless apparatus within the communication area, whereas selecting a second wireless communication standard having the maximum communication rate higher than that of the first wireless communication standard when there is no first wireless apparatus within the communication area, based on the network environment information;
establishing wireless connection with the target wireless apparatus by transmitting and receiving a frame to and from the target wireless apparatus in conformity with the selected wireless communication standard; and
executing data communication with the target wireless apparatus, with which the wireless connection unit has established the wireless connection, in conformity with the second wireless communication standard.
